(19) United States
(12) Patent Application Publication
(10) Pub. No.: US 2020/0262184 A1
(43) Pub. Date: Aug. 20, 2020

(54) ASYMMETRIC GLASS LAMINATES

(71) Applicant: CORNING INCORPORATED, CORNING, NY (US)

(72) Inventors: Thomas Michael Cleary, Elmira, NY (US); Timothy Scott Huten, Big Flats, NY (US)

(21) Appl. No.: 16/061,532

(22) PCT Filed: Dec. 12, 2016
(86) PCT No.: PCT/US2016/066107

§ 371 Date: Jun. 12, 2018

Related U.S. Application Data
(60) Provisional application No. 62/268,111, filed on Dec. 16, 2015.
(60) Provisional application No. 62/269,356, filed on Dec. 18, 2015.
(60) Provisional application No. 62/343,937, filed on Jun. 1, 2016.

(51) Int. Cl. B32B 17/10

(52) U.S. Cl. CPC B32B 17/10036; B32B 17/10788; B32B 17/1077; B32B 17/10816; B32B 2605/00; B32B 17/10137; B32B 17/10091; B32B 17/10761; B32B 2419/00; B32B 17/10119

(57) ABSTRACT

Principles and embodiments of the present disclosure relate to unique asymmetric laminates and methods that produce the laminates where the laminate includes an external glass substrate having a thickness (tₒ) and an internal glass substrate comprising a strengthened glass substrate having a thickness (tᵢ) in a range from about 0.05 mm to about 1 mm such that tₒ/tᵢ is in a range from about 3 to about 20.

### CROSS-REFERENCE TO RELATED APPLICATIONS

This application claims the benefit of priority under 35 U.S.C. § 119 of U.S. Provisional Application Ser. No. 62/268,111 filed on Dec. 16, 2015, U.S. Provisional Application Ser. No. 62/269,356 filed on Dec. 18, 2015, and U.S. Provisional Application Ser. No. 62/343,937 filed on Jun. 1, 2016, the content of each is relied upon and incorporated herein by reference in its entirety.

### TECHNICAL FIELD

Principles and embodiments of the present disclosure relate generally to a laminate comprising strengthened glass substrates, and methods of forming a laminate by bonding glass substrates having different thicknesses together with an interlayer.

### BACKGROUND

Laminates can be used as windows and glazing in architectural and transportation applications (e.g., vehicles including automobiles and trucks, rolling stock, locomotive and airplanes). Laminates can also be used as panels in balustrades and stairs, and as decorative panels or covering for walls, columns, elevator cabs, kitchen appliances and other applications. The laminates may be transparent, semitransparent, translucent or opaque and may comprise part of a window, panel, wall, enclosure, sign or other structure. Common types of such laminates may also be tinted or colored or include a component that is tinted or colored.

In certain applications, glass laminates having high mechanical strength, resistance to damage from impinging objects, and sound attenuating properties are desirable to provide a safe barrier while reducing the potential of at least one substrate forming the laminate fracturing due to surface cracks.

A glass substrate forming part of a laminate can be strengthened (chemically, thermally, and/or mechanically) to impart a surface compressive stress (CS) to the compressive stress region (or layer) that extends a distance from the surface into the glass substrate, where this distance into the glass substrate is referred to as a depth of compressive stress region (DOC). In chemically-strengthened glass substrates, the CS region is generated by an ion exchange process. In mechanically-strengthened glass substrates, the CS region is generated by a mismatch of the coefficient of thermal expansion between portions of the substrate. In thermally-strengthened substrates, the CS region is formed by heating the substrate to an elevated temperature above the glass transition temperature, near the glass softening point, and then cooling the glass surface regions more rapidly than the inner regions of the glass. The differential cooling rates between the surface regions and the inner regions generates a residual surface CS.

In these strengthened glasses, the CS induces tensile stress within the core of the material. The DOC of the resulting strengthened glass substrate may be a few to several tens of microns deep or hundreds of microns deep, depending on the strengthening method used.

In addition to withstanding external scratches, an automotive glazing must withstand internal impacts and meet safety standards. The ECE R43 headform test, which simulates impact events occurring from inside a vehicle, is a regulatory test that requires that laminates for motor vehicles fracture in response to specified internal impact. The glass is required to break at a certain impact load to prevent injury.

It would be desirable to provide a laminate that is not broken by external impact such as impact from a stone, yet is lighter weight, and is capable of absorbing considerable impact from a human body without causing serious injury. Improving one property of a glass laminate, however, tends to compromise other qualities of the laminate. It is therefore difficult to produce a laminate having a full range of desirable properties for use as automotive glazings and architectural panes.

### SUMMARY

Principles and embodiments of the present disclosure are directed to laminate glass structures that provide a combination of hardness, resilience, lightweight, high mechanical strength, resistance to damage from impinging objects, and sound attenuating properties.

Various embodiments are listed below. It will be understood that the embodiments listed below may be combined not only as listed below, but in other suitable combinations in accordance with the scope of the disclosure. Principles and embodiments of the present disclosure relate to unique asymmetric laminates and methods that produce the laminates where the laminate includes an external substrate having an external substrate thickness (to) and an internal substrate that is strengthened and has an internal substrate thickness (ti) in a range of 0.05 mm and 1 mm such that to/ti is in a range of 3 and 20.

The laminates described herein may be used in vehicles or architectural panels. In one or more embodiments, the laminate may be disposed in an opening of a vehicle body. Where the vehicle body is an automobile, the laminate could be used as a windshield, a side window, sunroof or rear windshield. The body of some embodiments may include railcar body, or an airplane body. In other embodiments, the laminate may be used in architectural panels, which may include a window, an interior wall panel, a modular furniture panel, a backsplash, a cabinet panel, or an appliance panel.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

Further features of embodiment of the present disclosure, their nature and various advantages will become more apparent upon consideration of the following detailed description, taken in conjunction with the accompanying drawings, which are also illustrative of the best mode contemplated by the applicants, and in which like reference characters refer to like parts throughout, where:

FIG. 1 illustrates an embodiment of a glass substrate surface having a plurality of cracks;

FIG. 2A illustrates an embodiment of an internal strengthened glass substrate having a thickness;

FIG. 2B illustrates an embodiment of an external glass substrate having a thickness;

FIG. 3 illustrates another exemplary embodiment of a laminate comprising an internal strengthened glass substrate and an external glass substrate;

FIG. 4 is a perspective view of a vehicle according to one or more embodiments;

FIG. 5 shows failure data for Example 1 comparing laminates according to one or more embodiments to a known laminate; and

FIG. 6 is a Weibull plot of data from Example 2.

### DETAILED DESCRIPTION

Before describing several exemplary embodiments, it is to be understood that the disclosure is not limited to the details of construction or process steps set forth in the following disclosure. The disclosure provided herein is capable of other embodiments and of being practiced or being carried out in various ways.

Reference throughout this specification to “one embodiment,” “certain embodiments,” “various embodiments,” “one or more embodiments” or “an embodiment” means that a particular feature, structure, material, or characteristic described in connection with the embodiment is included in at least one embodiment of the disclosure. Thus, the appearances of the phrases such as “in one or more embodiments,” “in certain embodiments,” “in various embodiments,” “in one embodiment” or “in an embodiment” in various places throughout this specification are not necessarily referring to the same embodiment. Furthermore, the particular features, structures, materials, or characteristics may be combined in any suitable manner in one or more embodiments.

As used herein, the phrase “laminates,” which may also be referred to as “laminate structures,” laminate glass structures, or “glazings,” relates to a transparent, semitransparent, translucent or opaque glass-based material. Aspects of this invention pertain to laminates and vehicles and architectural panels that incorporate such structures. Laminates according to one or more embodiments comprise at least two glass substrates. In vehicle applications such as automotive glazings, the internal glass substrate is exposed to a vehicle or automobile interior and the external glass substrate faces an outside environment of the automobile. In architectural applications, the internal glass substrate is exposed to a building, room, or furniture interior and the external glass substrate faces an outside environment of the building, room or furniture. In one or more embodiments, the external glass substrate and internal glass substrate are bonded together by an interlayer.

During use, it is desirable that the glass laminate resist fracture in response to external impact events. Fracture due to contact induced sub-surface damage has been identified as a failure mechanism. In addition, in response to internal impact events, such as the glass laminates being struck by a vehicle's occupant, it is desirable that the glass laminate retain the occupant in the vehicle yet dissipate energy upon impact in order to minimize injury.

Lightweight laminates are desired to reduce weight in automobiles. Such laminates typically include an external glass substrate, an internal glass substrate and an interlayer disposed between the external glass substrate and the internal glass substrate. A main cause of windshield replacements in the field is due to stone impact. Stone impact can cause fracture of the windshield by several mechanisms including blunt (Hertzian) contact, sharp contact and flexure. Blunt (Hertzian) creates a ring/cone crack which initiates from an existing flaw on the surface of the external glass substrate that faces the exterior of the automobile and is exposed and then propagates through thickness of the external glass substrate. Sharp contact creates damage that propagates through the thickness of the external glass substrate and then creates radial/median cracks. Flexure of the laminate activates flaws on the opposite surface of the external glass substrate (which opposes the first glass surface and faces the internal glass substrate and the interior of the automobile) and/or the surface of the internal glass substrate that is immediately adjacent the interior of the automobile. To optimize impact resistance, especially for a thin laminate, it would be desirable to address one or more of these mechanisms. As laminates are made thinner, flexure becomes more critical as the greater deflection during impact will result in higher and larger stress fields on surfaces #2 and #4.

It has been determined that installed automotive glazing may develop external scratches as deep as about 100 μm due to exposure to environmental abrasive materials such as rocks, silica sand, flying debris, etc. This penetration depth typically exceeds the typical depth of compressive layer, which could lead to the glass unexpectedly fracturing. The depth of penetration for the exposed surface of an internal glass substrate is notably lower than for the external glass substrate.

Contact damage to strengthened glass substrates can generate cracks (i.e., damage to a glass substrate that penetrates below the surface of the substrate), which penetrate beyond the DOC and into the CT region. Once a crack reaches the CT region, the internal tension can cause the crack tip to reach its critical stress intensity (KO, which is the critical value of stress intensity required to propagate the crack. This critical value determined for mode I loading in plane strain is referred to as the critical fracture toughness (K_{Ic}) of the material. The stress intensity factor (K) for mode I is designated K_{I} and applied to the crack opening mode, where the forces are normal to the direction of the crack. The strengthened glass substrate fractures (i.e., separates into two or more pieces) when the crack has propagated through the thickness of the glass. In silicate glasses, the strength of the atomic bonds primarily determines the resistance to fracture. Unlike fatigue, which is typically understood to be due to cyclical loading, the crack propagation and fracture in the compressively/tensilely stressed glass is due to the inherent stress within the glass material itself, and not from an externally applied force. The energy that drives the crack propagation comes from the tensile stresses in the inner region rather than from the force of the impact on the outer surface.

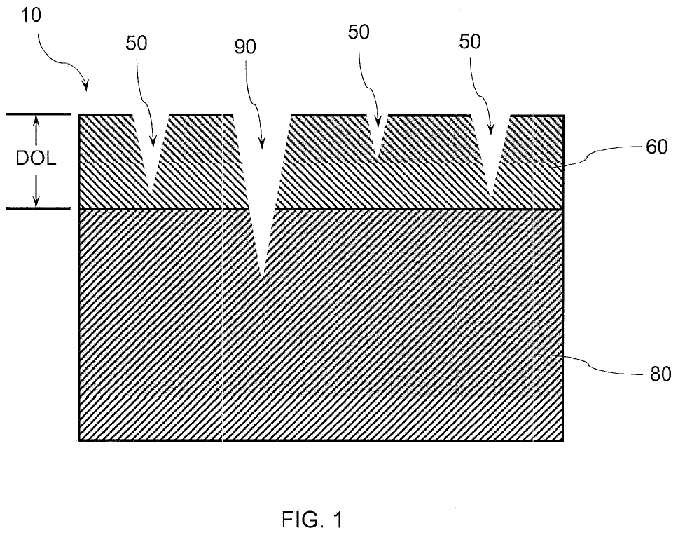

FIG. 1 illustrates an exemplary strengthened glass substrate 10 having a plurality of cracks, illustrating how subsurface damage can result in a fatigue style failure. Three cracks 50 in the CS region 60 of the exemplary strengthened glass substrate 10 that do not extend into the CT region 80 of the glass are shown, along with a single crack 90 that penetrates into the CT region 80 of the glass. Although the incorporation of a CS in a near surface region of the glass can inhibit crack propagation and failure of the glass substrate, if the damage extends beyond the DOC, and if the CT is of a high enough magnitude, the flaw will propagate over time until it reaches the materials critical stress intensity level (fracture toughness) and will ultimately fracture the glass. An analysis of measured flaw depths from used auto glazings comprising an external glass substrate and an internal glass substrate showed that the external glass substrates have deeper subsurface damage than the internal glass substrates, and the external glass substrates are therefore exposed to more severe contact damage. The CT can be varied by changing the thickness of the strengthened glass substrate, while maintaining the same CS magnitude and DOC.

It has been found that by adjusting the CT value of a strengthened glass substrate, the substrate can be made less susceptible to failure mechanisms initiated by surface damage that penetrates through the DOC to the CT region. The CT value of the strengthened glass substrate may be controlled by adjusting the magnitude of the CS, the DOC, and/or the thickness of the glass substrate.

Principles and embodiments of the present disclosure relate to unique asymmetric laminates and methods that produce the asymmetric laminates that have improved damage tolerance. In one or more embodiments, the laminate comprising an external glass substrate which may be a strengthened glass substrate having a first CT value and an internal glass substrate which may be a strengthened glass substrate having a second CT value, where the first CT value is less than the second CT value. In one or more embodiments, the first CT value is defined by a first thickness, a first DOC, and a first CS magnitude, and the second CT value is defined by a second thickness, a second DOC and a second CS magnitude.

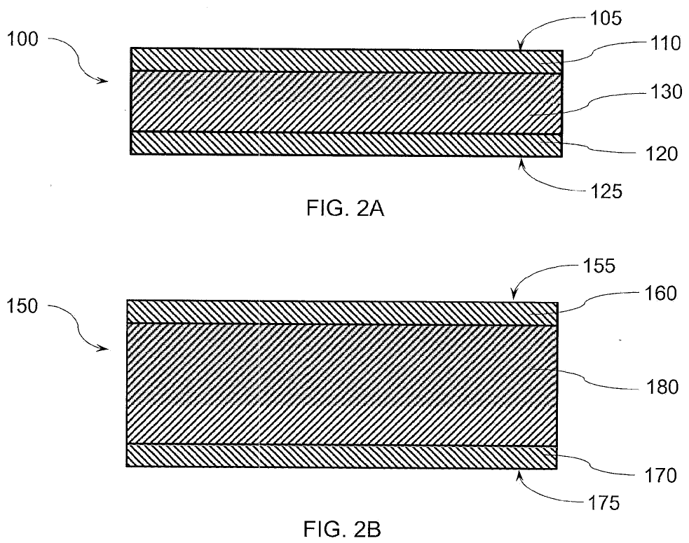

FIG. 2A illustrates an embodiment of an internal strengthened glass substrate. The internal strengthened glass substrate 100 has a first glass surface 105 and a second glass surface 125 opposite the first glass surface. In the embodiment shown, the internal strengthened glass substrate includes CS regions 110, 120 that extend from first glass surface 105 and second glass surface 125, respectively, to a DOC. At the DOC, the stress changes from compressive to tensile. The tensile stress defines a CT region 130 that is between the CS regions 110, 120.

FIG. 2B illustrates an embodiment of an external glass substrate 150, which is shown as an external strengthened glass substrate. It will be understood that the external glass substrate 150 can be strengthened or unstrengthened. In the embodiment shown, the external strengthened glass substrate 150 has a third glass surface 155 and a fourth glass surface 175 opposite the third glass surface. In the embodiment shown, the external strengthened glass substrate includes CS regions 160, 170 that extend inward from third glass surface 155 and fourth glass surface 175, respectively, to a DOC. At the DOC, the stress changes from compressive to tensile. The tensile stress defines a CT region 180 between the two CS regions 160, 170.

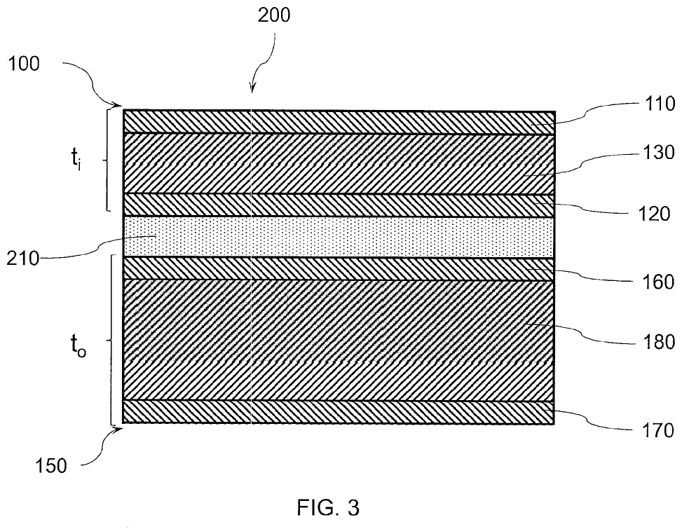

FIG. 3 illustrates an embodiment of a laminate having an external glass substrate and an internal strengthened glass substrate. The laminate 200 comprises an external glass substrate 150 having a second thickness shown as thickness (tₒ) laminated by an interlayer 210 to an internal strengthened glass substrate 100 having a first thickness shown as thickness (tᵢ) less than the second thickness shown as thickness (tₒ). The external glass substrate 150 is shown as a strengthened substrate, and it will be understood that in one or more embodiments, the external glass substrate 150 can be unstrengthened, for example, an annealed glass substrate such as a soda lime glass substrate. The laminate 200 can be arranged used as an automotive or architectural glazing such that the external substrate 150 faces an external environment (e.g., the exterior of the automobile or building), and the internal glass substrate 100 faces the internal environment (e.g., the inside of a automobile or a building).

As used herein, the term “strengthened glass substrate” refers to glass substrates that may be strengthened chemically, mechanically, thermally or by various combinations of chemically, mechanically and/or thermally, to impart a compressive stress region with a surface compressive stress value, and a central tension region with a maximum CT value. The first CT value and the second CT value as used to describe the external glass sheet and the internal glass sheet refer to the maximum CT value. Such strengthened glass substrates also include corresponding surface CS, and a compressive stress region that extends from a surface to a DOC) Any one or more of the magnitude of the surface CS, the DOC, and the magnitude of the maximum CT value can be tailored by the strengthening process. As used herein DOC refers to the depth at which the stress transitions from compressive to tensile. Unless otherwise specified, CT and CS are expressed herein in megaPascals (MPa), whereas thickness and DOC are expressed in millimeters or microns. It will be appreciated that CT is dependent on three parameters—CS, DOC and thickness. As an example, to maintain a CT value, for example at 30 MPa or less, as the DOC is increased, either the CS would need to be decreased or the increase the thickness to maintain the CT at 30 MPa or less.

CS and DOC are is measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety.

When FSM is used to measure the compressive stress, the CS is related to the CT by the following approximate relationship (Equation 1): CT≈(CS×DOC)/(thickness−2×DOC), where thickness is the total thickness of the strengthened glass substrate. A mechanically-strengthened glass substrate may include a compressive stress region and a central tension region generated by a mismatch of the coefficient of thermal expansion between portions of the substrate. A chemically-strengthened glass substrate may include a compressive stress region and a central tension region generated by an ion exchange process. In a chemically strengthened glass substrate, the replacement of smaller ions by larger ions at a temperature below that at which the glass network can relax produces a distribution of ions across the surface of the glass that results in a stress profile. The larger volume of the incoming ion produces a CS on the surface portion of the substrate and tension (CT) in the center of the glass. In a thermally-strengthened substrate, the CS region is formed by heating the substrate to an elevated temperature above the glass transition temperature, near the glass softening point, and then cooling the glass surface regions more rapidly than the inner regions of the glass. The differential cooling rates between the surface regions and the inner regions generates a residual surface CS, which in turn generates a corresponding CT in the center region of the glass. In one or more embodiments, the a glass substrates excludes annealed soda lime glass.

One or more embodiments pertain to laminates that can be used for applications such as automotive glazings. The laminates described in this disclosure are highly asymmetric with respect to the thickness ratio of an external glass substrate to an internal glass substrate. In specific embodiments, either one or both the external glass substrate and the internal glass substrate comprise a strengthened glass substrate (as described herein).

In one or more embodiments, the external glass substrate has a greater thickness than the internal glass substrate and provides resistance to sharp impact, as the damage created by this impact generally must propagate at least to the mid-plane of the external glass substrate before it can create radial/median fractures. According to one or more embodiments, the overall thickness of the laminate is less than conventional glazings, and therefore, provides high impact resistance to both blunt and sharp impact events because the laminate dissipates impact energy by deflection. The thin, strengthened internal glass substrate provides resistance to failure of the internal glass substrate due to the high biaxial flexure stresses. In applications such as automotive glazings, the external glass substrate typically is subjected to more severe damage resulting in deeper flaw depths, and therefore according to one or more embodiments, the thickness of the external glass substrate is increased.

In one or more embodiments, by minimizing the CT, a more durable (damage tolerant) external strengthened glass substrate is achieved. In one or more embodiments, by increasing the first thickness of the external strengthened glass substrate, the internal stored strain energy of this substrate is reduced to improve its performance to contact damage induced fatigue. However, in certain embodiments, a laminate is provided comprising an external glass substrate which comprises an annealed glass substrate that has not been strengthened thermally or chemically.

In embodiments in which the external glass substrate is not strengthened, the thickness of such external glass substrate may be tailored to provide resistance to sharp impact as the damage created by the sharp impact must propagate at least to the mid-plane of the external glass substrate before it can create radial/median fractures. In this manner, the external glass substrate provides high impact resistance to both blunt and sharp impact events because the laminate dissipates impact energy by deflection. Maintaining a minimum thickness of the external glass substrate provides a barrier layer that the initial damage must propagate through to create radial/median fractures. Dissipating impact energy through deflection of the laminate results in lower contact stresses. Thus, according to one or more embodiments, the external glass substrate may be an annealed glass substrate that is not strengthened.

In other embodiments, the external glass substrate is strengthened as described herein, and the CT in the external glass substrate is reduced to make the external strengthened glass substrate less prone to fatigue failure. One approach to achieving this reduction in CT in the external glass substrate is to increase the thickness of the external glass substrate so that the residual central strain resulting from strengthening has a greater thickness to distribute itself. The magnitude of the resulting CT resulting from the central strain is a function of the thickness it is spread over. The resulting stresses need to be in force balance, and therefore, if the residual CS magnitude and depth are held constant, the only way to reduce the residual tensile stress is to distribute it over a greater depth. The effect of the thickness on CT can be determined by equation 1 above.

Thus, in one or more embodiments, the first CT value of the external glass substrate can be reduced by increasing the first thickness while keeping a first DOC and a first CS magnitude constant. Another option to reduce the first CT value of the external glass substrate is to reduce the magnitude of the first CS by changing glass composition or strengthening process conditions for the first substrate. Yet another method to improve fatigue performance is by increasing the DOC of the external glass substrate to minimize the population of flaws that penetrate beyond the DOC into the CT region. However, making the DOC deeper also increases the CT which increases the risk of fatigue failure for those flaws that do penetrate through. In various embodiments, the first CT value of the external glass substrate can be reduced by reducing the first CS magnitude, increasing the first DOC, and increasing the first thickness to compensate for the increased first DOC.

In one or more embodiments, the external glass substrate has a first thickness (tₒ), and an internal glass substrate has a second thickness (tᵢ) that is in a range of 0.1 mm and 1 mm. In one or more embodiments, the laminate exhibits the ratio of thicknesses (tₒ/tᵢ) that is in a range of 3 and 20. According to one or more embodiments, the ratio of thicknesses (tₒ/tᵢ) is greater than 3:1, for example in a range of 3:1 to 20:1, 3:1 to 15:1, 3:1 to 10:1, 4:1 to 20:1, 4:1 to 15:1, 4:1 to 10:1, 4.5:1 to 20:1, 4.5:1 to 15:1 4.5:1 to 10:1, 5:1 to 20:1, 5:1 to 15:1, 5:1 to 10:1, 5.75:1 to 20:1, 5.75:1 to 15:1 or 5.75:1 to 10:1.

In the various embodiments, the external strengthened glass substrate has a first thickness (tₒ) defined by the third glass surface 155 and the fourth glass surface 175. The third glass surface and fourth glass surface can be major glass surfaces forming the majority of the external strengthened glass substrate surface area.

In one or more embodiments, the first thickness (tₒ) is in the range of about 1.5 mm to about 6 mm, about 1.5 mm to about 5.5 mm, 1.5 mm to about 5 mm, about 1.5 mm to about 4.5 mm, about 1.5 mm to about 4 mm, about 1.5 to about 3.9 mm about 1.5 to about 3.8 mm, about 1.5 to about 3.7 mm, about 1.5 to about 3.6 mm about 1.5 to about 3.5 mm, about 1.5 to about 3.4 mm, about 1.5 to about 3.3 mm about 1.5 to about 3.2 mm about 1.5 to about 3.1 mm, about 1.5 to about 3 mm, about 1.5 to about 2.9 mm, about 1.5 to about 2.8 mm about 1.5 to about 2.7 mm, about 1.5 to about 2.6 mm, about 1.5 to about 2.5 mm about 1.5 to about 2.4 mm about 1.5 to about 2.3 mm, about 1.5 to about 2.2 mm, about 1.5 to about 2.1 mm, about 1.5 to about 2 mm, about 1.5 to about 1.9 mm, about 1.5 to about 1.8 mm, about 1.5 to about 1.7 mm, or about 1.5 to about 1.6 mm. The thickness values described herein are maximum thicknesses. In one or more embodiments, the external strengthened glass substrate has a substantially uniform thickness. In one or more embodiments, the external strengthened glass substrate may have a wedge shape. In such embodiments, the thickness of the external strengthened glass substrate at one edge may be greater than the thickness of the opposite edge. In one or more embodiments, the longest edges of the external strengthened glass substrate have thicknesses that differ from one another, while the thicknesses of the other edges (shorter edges) are the same with respect to one another but vary along the length thereof to form the wedge shape. In one or more embodiments in which the external strengthened glass substrate has a wedge shape, the thickness ranges provided above are maximum thicknesses. In one or more embodiments, the external strengthened glass substrate has a wedge shape while the internal strengthened glass substrate has a substantially uniform thickness.

In one or more embodiments in which the external glass substrate is strengthened, the first CT value may be 25 MPa or less, or 30 MPa or less, or 40 MPa or less, or 45 MPa or less. In one or more embodiments, the external strengthened glass substrate may have a CT in the range of about 10 MPa to about 40 MPa, or in the range of about 20 MPa to about 30 MPa, including values of 29 MPa, 28 MPa, 27 MPa, 26 MPa, 25, MPa, 24 MPa, 23 MPa, 22 MPa and 21 MPa and ranges including each of these values as endpoints, for example, the range of about 21 MPa to about 29 MPa.

In one or more embodiments, the first CT value may be controlled by using a different glass composition for the external strengthened glass substrate. In various embodiments, the external strengthened glass substrate has a different glass composition than the internal strengthened glass substrate. By using a different glass composition, the external glass substrate and the internal glass substrate can be strengthened using the same technique but which result in differing CS, CT or DOC values from one another due to the compositional difference. In some instances, the strengthening process utilized may be modified to control the first CT value.

In one or more embodiments in which the external glass substrate comprises a strengthened glass substrate, at least one surface of the external strengthened glass substrate has a first surface CS magnitude (in absolute terms) of at least 300 MPa, or at least 400 MPa, or at least 500 MPa, or at least 600 MPa, or at least 700 MPa, at least 800 MPa, at least 900 MPa, or at least 1000 MPa. In various embodiments, the first CS magnitude may be in the range of about 300 MPa to about 1000 MPa, specifically, in the range of about 400 MPa to about 1000 MPa, or in the range of about 500 MPa to about 1000 MPa, or in the range of about 600 MPa to about 1000 MPa, or in the range of about 700 MPa to about 1000 MPa, or in the range of about 800 MPa to about 1000 MPa. In various embodiments, both surfaces of the external strengthened glass substrate may be strengthened to the same CS magnitude.

In one or more embodiments in which the external glass substrate comprises a strengthened glass substrate, the external strengthened glass substrate may have a first DOC of 15 μm or greater, 20 μm or greater, 25 μm or greater, 30 μm or greater, 35 μm or greater, 40 μm or greater, 45 μm or greater, or 50 μm or greater. In various embodiments in which the external glass substrate comprises a strengthened glass substrate, the first DOC may be in the range of about 30 μm to about 175 μm, or in the range of about 30 μm to about 170 μm, or in the range of about 30 μm to about 160 μm, or in the range of about 30 μm to about 150 μm, or in the range of about 30 μm to about 140 μm, or in the range of about 30 μm to about 130 μm, or in the range of about 30 μm to about 120 μm, or in the range of about 30 μm to about 110 μm, or in the range of about 30 μm to about 100 μm, or in the range of about 30 μm to about 90 μm, or in the range of about 30 μm to about 80 μm, or in the range of about 30 μm to about 70 μm, or in the range of about 30 μm to about 60 μm, or in the range of about 30 μm to about 50 μm, 35 μm to about 175 μm, or in the range of about 35 μm to about 170 μm, or in the range of about 35 μm to about 160 μm, or in the range of about 35 μm to about 150 μm, or in the range of about 35 μm to about 140 μm, or in the range of about 35 μm to about 130 μm, or in the range of about 35 μm to about 120 μm, or in the range of about 35 μm to about 110 μm, or in the range of about 35 μm to about 100 μm, or in the range of about 35 μm to about 90 μm, or in the range of about 35 μm to about 80 μm, or in the range of about 35 μm to about 70 μm, or in the range of about 35 μm to about 60 μm, or in the range of about 35 μm to about 50 μm, 40 μm to about 175 μm, or in the range of about 40 μm to about 170 μm, or in the range of about 40 μm to about 160 μm, or in the range of about 40 μm to about 150 μm, or in the range of about 40 μm to about 140 μm, or in the range of about 40 μm to about 130 μm, or in the range of about 40 μm to about 120 μm, or in the range of about 40 μm to about 110 μm, or in the range of about 40 μm to about 100 μm, or in the range of about 40 μm to about 90 μm, or in the range of about 40 μm to about 80 μm, or in the range of about 40 μm to about 70 μm, or in the range of about 40 μm to about 60 μm, or in the range of about 40 μm to about 50 μm, or in the range of about 45 μm to about 48 μm, as measured from at least one surface of the external strengthened glass substrate. In one or more embodiments, the external strengthened glass substrate may have any of the above recited DOC values combined with a first surface CS magnitude of at least 300 MPa, or at least 400 MPa, or at least 500 MPa, or at least 600 MPa, or at least 700 MPa, or at least 800 MPa, for example, in the range of about 400 MPa to about 700 MPa, specifically, in the range of 400 MPa to 500 MPa.

In various embodiments in which the external glass substrate comprises a strengthened glass substrate, in a non-limiting example, the first CS of the strengthened glass substrate is in the range of about 300 MPa to about 1000 MPa, the first DOC is in the range of 40 μm to about 80 μm and the CT is less than about 30 MPa.

In various embodiments in which the external glass substrate includes a strengthened glass substrate, each of the two surfaces of the external strengthened glass substrate may have different compressive stress DOC and/or different surface CS magnitude by controlling the strengthening process separately for each substrate surface, as described herein.

In various embodiments, the internal glass substrate has a first glass surface 105 and a second glass surface 125 opposite the first glass surface defining a second thickness (tᵢ) between the first glass surface and the second glass surface. The first glass surface and second glass surface can be major glass surfaces forming the majority of the internal strengthened glass substrate surface area.

In one or more embodiments, the second thickness (tᵢ) may be in the range of about 0.05 mm to about 1 mm, for example, in the range of about 0.05 to about 0.9 mm, in the range of about 0.05 to about 0.8 mm, in the range of about 0.05 to about 0.7 mm, in the range of about 0.05 to about 0.6 mm, in the range of about 0.05 to about 0.5 mm, in the range of about 0.05 to about 0.4 mm, in the range of about 0.05 to about 0.3 mm, in the range of about 0.05 to about 0.2 mm, or in the range of about 0.05 to about 0.15 mm. The thickness values described herein are maximum thicknesses. In one or more embodiments, the internal glass substrate has a substantially uniform thickness. In one or more embodiments, the internal glass substrate may have a wedge shape. In such embodiments, the thickness of the internal glass substrate at one edge may be greater than the thickness of the opposite edge. In one or more embodiments, the longest edges of the internal glass substrate have thicknesses that differ from one another, while the thicknesses of the other edges (shorter edges) are the same with respect to one another but vary along the length thereof to form the wedge shape. In one or more embodiments in which the internal glass substrate has a wedge shape, the thickness ranges provided above are maximum thicknesses. In one or more embodiments, the internal glass substrate has a wedge shape while the external glass substrate has a substantially uniform thickness.

In one or more embodiments, the second CT value of the internal glass substrate may be 25 MPa or less, or 30 MPa or less, or 40 MPa or less, or 45 MPa or less. In one or more embodiments, the internal strengthened glass substrate may have a CT in the range of about 10 MPa to about 40 MPa, or in the range of about 20 MPa to about 30 MPa, including values of 29 MPa, 28 MPa, 27 MPa, 26 MPa, 25, MPa, 24 MPa, 23 MPa, 22 MPa and 21 MPa and ranges including each of these values as endpoints, for example, the range of about 21 MPa to about 29 MPa.

In one or more embodiments, the second CT value of the substrate of the internal glass substrate may be controlled by using a different glass composition than the composition used for the external strengthened glass substrate. For example, where differing glass compositions are used, the external glass substrate and the internal glass substrate can be strengthened using the same technique but which result in differing CS, CT or DOC values from one another due to the compositional difference. In some instances, the strengthening process utilized may be modified to control the second CT value.

In one or more embodiments, at least one surface of the internal strengthened glass substrate has a second surface CS magnitude of at least 300 MPa, or at least 400 MPa, or at least 500 MPa, or at least 600 MPa, or at least 700 MPa, at least 800 MPa, at least 900 MPa, or at least 1000 MPa. In various embodiments, the second surface CS magnitude may be in the range of about 300 MPa to about 1000 MPa, specifically, in the range of about 400 MPa to about 1000 MPa, or in the range of about 500 MPa to about 1000 MPa, or in the range of about 600 MPa to about 1000 MPa, or in the range of about 700 MPa to about 1000 MPa, or in the range of about 800 MPa to about 1000 MPa. In various embodiments, both surfaces of the internal strengthened glass substrate may be strengthened to the same CS magnitude.

In one or more embodiments, the second DOC of the internal glass substrate may be in the range of about 30 μm to about 90 μm, or in the range of about 40 μm to about 80 μm, or in the range of about 40 μm to about 70 μm, or in the range of about 40 μm to about 60 μm, or in the range of about 40 μm to about 50 μm, for at least one surface of the internal strengthened glass substrate.

In various embodiments, each of the two surfaces of the internal strengthened glass substrate may have different DOC values and/or different surface CS magnitudes from one another by controlling the strengthening process separately for each substrate surface, as described above.

In one or more embodiments, the laminate is configured to be an automotive glazing for an automobile, and the external glass substrate faces an outside environment of the automobile and the internal strengthened glass substrate faces an interior of the automobile. In one or more embodiments, the external strengthened glass substrate is mechanically strengthened, while the internal strengthened glass substrate is chemically strengthened. In one or more embodiments, the external glass substrate is not strengthened, while the internal glass substrate is strengthened, either chemically or mechanically.

In one or more embodiments, the external glass substrate is chemically strengthened; while the internal strengthened glass substrate is mechanically strengthened. In some embodiments, both the external and internal substrates are chemically strengthened. In other embodiments, both the external and internal substrates are mechanically strengthened. Additionally or alternatively, one or both the external and internal substrates are strengthened mechanically and chemically. In one or more embodiments, the external glass substrate is not strengthened, while the internal glass substrate is strengthened, either chemically or mechanically.

In one or more embodiments, the external glass substrate is laminated to the internal strengthened glass substrate by an interlayer. In various embodiments, the interlayer is a polymer interlayer selected from the group consisting of polyvinyl butyral (PVB), ethylenevinylacetate (EVA), polyvinyl chloride (PVC), ionomers, and thermoplastic polyurethane (TPU). The interlayer may be applied as a preformed polymer interlayer. In some instances, the polymer interlayer can be, for example, a plasticized polyvinyl butyral (PVB) sheet. In various embodiments, the polymer interlayer can comprise a monolithic polymer sheet, a multilayer polymer sheet, or a composite polymer sheet.

The interlayer may have a thickness of at least 0.125 mm, or at least 0.25 mm, or at least 0.38 mm, or at least 0.5 mm, or at least 0.7 mm, or at least 0.76 mm, or at least 0.81 mm, or at least 1.0 mm, or at least 1.14 mm, or at least 1.19 mm, or at least 1.2 mm. The interlayer may have a thickness of less than or equal to 1.6 mm (e.g., from 0.4 mm to 1.2 mm, such as about 0.4 mm, 0.5 mm, 0.6 mm, 0.7 mm, 0.8 mm, 0.9 mm, 1.0 mm, 1.1 mm or 1.2 mm). In various embodiments, the interlayer can cover most or, preferably, substantially all of the two opposed major faces of the strengthened glass substrates. The interlayer may also cover the edge faces of the strengthened glass substrates. In one or more embodiments, the interlayer may have a wedge shape or may have a substantially uniform thickness. In one or more embodiments, the thickness of the interlayer along an edge may be greater than the thickness of the interlayer along an opposing edge. In one or more embodiments, the longest edges of the interlayer have thicknesses that differ from one another, while the thicknesses of the other edges (shorter edges) are the same with respect to one another but vary along the length thereof to form the wedge shape. In one or more embodiments in which the interlayer has a wedge shape, the thickness ranges provided above are maximum thicknesses. In one or more embodiments, the interlayer has a wedge shape while the first strengthened glass substrate and/or the second glass substrate has a substantially uniform thickness.

In one or more embodiments, the total thickness of the laminate (including the external glass substrate, the interlayer and the internal glass substrate) is less than about 7 mm, less than about 6.9 mm, less than about 6.8 mm, less than about 6.7 mm, less than about 6.6 mm, less than about 6.5 mm, less than about 6.4 mm, less than about 6.3 mm, less than about 6.2 mm, less than about 6.1, mm, less than about 6 mm, less than about 5.9 mm, less than about 5.8 mm, less than about 5.7 mm, less than about 5.6 mm, less than about 5.5 mm, less than about 5.4 mm, less than about 5.3 mm, less than about 5.2 mm, less than about 5.1, mm, less than about 4 mm, less than about 3.9 mm, less than about 3.8 mm, less than about 3.7 mm, less than about 3.6 mm, less than about 3.5 mm, less than about 3.4 mm, less than about 3.3 mm, less than about 3.2 mm, less than about 3.1, mm, less than about 3 mm, less than about 2.9 mm, less than about 2.8 mm, less than about 2.7 mm, less than about 2.6 mm, less than about 2.5 mm, less than about 2.4 mm, less than about 2.3 mm, less than about 2.2 mm, less than about 2 mm. In some embodiments, the total thickness of the laminate is about 2 mm or greater, about 2.2 mm or greater, about 2.4 mm or greater, about 2.5 mm or greater, about 2.6 mm or greater, about 2.8 mm or greater, about 3 mm or greater, about 3.2 mm or greater, about 3.4 mm or greater, about 3.5 mm or greater, about 3.6 mm or greater, about 3.8 mm or greater, about 4 mm or greater, about 4.2 mm or greater, about 4.4 mm or greater, about 4.5 mm or greater, about 4.6 mm or greater, about 4.8 mm or greater, or about 5 mm or greater. In some instances, the total thickness of the laminate is in the range from about 2 mm to about 7 mm, from about 2.2 mm to about 7 mm, from about 2.4 mm to about 7 mm, from about 2.5 mm to about 7 mm, from about 2.6 mm to about 7 mm, from about 2.8 mm to about 7 mm, from about 3 mm to about 7 mm, from about 3.2 mm to about 7 mm, from about 2 mm to about 6.8 mm, from about 2 mm to about 6.6 mm, from about 2 mm to about 6.5 mm, from about 2 mm to about 6.4 mm, from about 2 mm to about 6.2 mm, from about 2 mm to about 6 mm, from about 2 mm to about 5.8 mm, from about 2 mm to about 5.6 mm, from about 2 mm to about 5.5 mm, from about 2 mm to about 5.4 mm, from about 2 mm to about 5.2 mm, from about 2 mm to about 5 mm, from about 2 mm to about 4.8 mm, or from about 2 mm to about 4.6 mm.

In one or more embodiments, the laminate may have added functionality in terms of incorporating display aspects (e.g., heads up display, projection surfaces, and the like), antennas, solar insulation, acoustic performance (e.g., sound dampening), anti-glare performance, anti-reflective performance, scratch-resistance and the like. Such functionality may be imparted by coatings or layers applied to the exposed surfaces of the laminate or to interior (unexposed) surfaces between laminate substrates (e.g., between the glass substrates or between a glass substrate and an interlayer). In some embodiments, the laminate may have a thickness or configuration to enable improved optical performance when the laminate is used as a heads-up display (e.g., by incorporating a wedged shaped polymer interlayer between the glass sheets or by shaping one of the glass substrates to have a wedged shape). In one or more embodiments, the laminate includes a textured surface that provides anti-glare functionality and such textured surface may be disposed on an exposed surface or an interior surface that is unexposed. In one or more embodiments, the laminate may include an anti-reflective coating, a scratch-resistant coating or a combination thereof disposed on an exposed surface. In one or more embodiments, the laminate may include an antenna disposed on an exposed surface, and interior surface that is not exposed or embedded in any one of the glass substrates. In one or more embodiments, the polymer interlayer can be modified to have one or more of the following properties: ultraviolet (UV) absorption, Infrared (IR) absorption, IR reflection, acoustic control/dampening, adhesion promotion, and tint. The polymer interlayer can be modified by a suitable additive such as a dye, a pigment, dopants, etc. to impart the desired property.

The improved mechanical performance of the laminates described herein can prolong the life thereof and reduce replacement rates of such laminates. This becomes more beneficial as such laminates incorporate the added functionality described herein, and thus become more costly to repair or replace. In some embodiments, the prolonged life and reduced replacement rates are even more beneficial when the laminates with added functionality are used in auto glazing or, more specifically, as high performance windshields.

An aspect of the disclosure relates to a laminate comprising an external strengthened glass substrate having a first damage tolerance as measured by Indentation Fracture Measurement; and an internal strengthened glass substrate having a second damage tolerance as measured by the same Indentation Fracture Measurement as the first damage tolerance, wherein the external strengthened glass substrate and the internal strengthened glass substrate are laminated together, and the first damage tolerance is greater than the second damage tolerance.

In one or more embodiments, at least one surface of the external strengthened glass substrate can withstand a surface flaw having a depth of at least 100 μm, at least 95 μm, at least 90 μm, at least 85 μm, at least 80 μm, at least 75 μm, at least 70 μm, at least 65 μm, at least 60 μm, at least 55 μm, or at least 50 μm before the laminate suffers a fatigue-style failure.

The materials for the external glass substrate and the internal strengthened glass substrate may be varied. According to one or more embodiments, the materials for the internal glass substrate and the internal strengthened glass substrate may be the same material or different materials. In exemplary embodiments, one or both of the external strengthened glass substrate and the internal strengthened glass substrate may be glass (e.g., soda lime glass, alkali aluminosilicate glass, alkali containing borosilicate glass and/or alkali aluminoborosilicate glass) or glass-ceramic (including Li₂O—Al₂O₃—SiO₂ system (i.e. LAS-System) glass ceramics, MgO—Al₂O₃—SiO₂ System (i.e. MAS-System) glass ceramics, glass ceramics including crystalline phases of any one or more of mullite, spinel, α-quartz, β-quartz solid solution, petalite, lithium dissilicate, β-spodumene, nepheline, and alumina).

In some embodiments, the compositions used for a glass substrate may be batched with 0-2 mol. % of at least one fining agent selected from a group that includes Na₂SO₄, NaCl, NaF, NaBr, K₂SO₄, KCl, KF, KBr, and SnO₂.

The glass substrates may be provided using a variety of different processes. For instance, where the substrate includes a glass substrate, exemplary glass substrate forming methods include float glass processes and down-draw processes such as fusion draw and slot draw.

A glass substrate prepared by a float glass process may be characterized by smooth surfaces and uniform thickness is made by floating molten glass on a bed of molten metal, typically tin. In an example process, molten glass that is fed onto the surface of the molten tin bed forms a floating glass ribbon. As the glass ribbon flows along the tin bath, the temperature is gradually decreased until the glass ribbon solidifies into a solid glass substrate that can be lifted from the tin onto rollers. Once off the bath, the glass substrate can be cooled further and annealed to reduce internal stress.

Down-draw processes produce glass substrates having a uniform thickness that possess relatively pristine surfaces. Because the average flexural strength of the glass substrate is controlled by the amount and size of surface flaws, a pristine surface that has had minimal contact has a higher initial strength. When this high strength glass substrate is then further strengthened (e.g., chemically), the resultant strength can be higher than that of a glass substrate with a surface that has been lapped and polished. Down-drawn glass substrates may be drawn to a thickness of less than about 2 mm. In addition, down drawn glass substrates have a very flat, smooth surface that can be used in its final application without costly grinding and polishing.

The fusion draw process, for example, uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank as two flowing glass films. These outside surfaces of the drawing tank extend down and inwardly so that they join at an edge below the drawing tank. The two flowing glass films join at this edge to fuse and form a single flowing glass substrate. The fusion draw method offers the advantage that, because the two glass films flowing over the channel fuse together, neither of the outside surfaces of the resulting glass substrate comes in contact with any part of the apparatus. Thus, the surface properties of the fusion drawn glass substrate are not affected by such contact.

The slot draw process is distinct from the fusion draw method. In slot draw processes, the molten raw material glass is provided to a drawing tank. The bottom of the drawing tank has an open slot with a nozzle that extends the length of the slot. The molten glass flows through the slot/nozzle and is drawn downward as a continuous substrate and into an annealing region.

Once formed, a glass substrate may be strengthened to form a strengthened glass substrate, as described herein. It should be noted that glass ceramic substrates may also be strengthened in the same manner as glass substrates.

Examples of glasses that may be used in the glass substrates described herein may include alkali aluminosilicate glass compositions or alkali aluminoborosilicate glass compositions, though other glass compositions are contemplated. Such glass compositions may be characterized as ion exchangeable. As used herein, “ion exchangeable” means that a substrate comprising the composition is capable of exchanging cations located at or near the surface of the substrate with cations of the same valence that are either larger or smaller in size. One example glass composition comprises SiO₂, B₂O₃ and Na₂O, where (SiO₂+B₂O₃)≥66 mol. %, and Na₂O≥9 mol. %. Suitable glass compositions, in some embodiments, further comprise at least one of K₂O, MgO, and CaO. In a particular embodiment, the glass compositions used in the substrate can comprise 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example glass composition suitable for the substrates comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≤(Li₂O+Na₂O+K₂O)≤20 mol. % and 0 mol. %≤(MgO+CaO)≤10 mol. %.

A still further example glass composition suitable for the substrates comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≤(Li₂O+Na₂O+K₂O)≤18 mol. % and 2 mol. %≤(MgO+CaO)≤7 mol. %.

In a particular embodiment, an alkali aluminosilicate glass composition suitable for the substrates comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio ((Al₂O₃+B₂O₃)/Σmodifiers)>1, where in the ratio the components are expressed in mol. % and the modifiers are alkali metal oxides. This glass composition, in particular embodiments, comprises: 58-72 mol. % SiO₂; 9-17 mol. % Al₂O₃; 2-12 mol. % B₂O₃; 8-16 mol. % Na₂O; and 0-4 mol. % K₂O, wherein the ratio ((Al₂O₃+B₂O₃)/Σmodifiers)>1.

In still another embodiment, the substrates may include an alkali aluminosilicate glass composition comprising: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. % SiO₂+B₂O₃+CaO 69 mol. %; Na₂O+K₂O+B₂O₃+MgO+CaO+SrO>10 mol. %; 5 mol. %≤MgO+CaO+SrO≤8 mol. %; (Na₂O+B₂O₃)—Al₂O₃≤2 mol. %; 2 mol. % Na₂O—Al₂O₃≤6 mol. %; and 4 mol. % (Na₂O+K₂O)—Al₂O₃≤10 mol. %.

In an alternative embodiment, the substrates may comprise an alkali aluminosilicate glass composition comprising: 2 mol % or more of Al₂O₃ and/or ZrO₂, or 4 mol % or more of Al₂O₃ and/or ZrO₂.

In various embodiments, the external glass substrate exhibits a first damage tolerance after being subjected to an Indentation Fracture Measurement, as described herein. In some embodiments, the external strengthened glass substrate exhibits a first damage tolerance that includes at least 50% survival under the Indentation Fracture Measurement, using a Vickers indenter and a load of at least 8 N, or at least 10 N, or at least 12 N, or at least 14 N, or at least 16 N, or at least 20 N (before the external strengthened glass substrate fractures). In one or more embodiments, the first damage tolerance may be exhibited as measured by an Indentation Fracture Measurement using a Vickers indenter and a load in the range of 8 N to 20 N, in the range of 8 N to 16 N, in the range of 10 N to 20 N, in the range of 10 N to 16 N or in the range of 12 N to 20 N. As used herein, “Indentation Fracture Measurement” refers to a test utilizing an indenter (such as a Vickers diamond indenter having a 136° pyramidal diamond indenter that forms a square indent) to impart damage to the laminate, according to the following description. The indenter is pressed into the glass substrate by an accurately controlled test load at the specified value. After the desired test load is applied, the glass substrate is moved with respect to the indenter to produce a scratch having a length of 5-10 mm. Five parallel scratches of approximately the same length and spaced apart in the range of 10-20 mm are produced using the same procedure. The size of the sample used for such a test can be 2.54 cm×2.54 cm or 5.08 cm×5.08 cm. The parts are monitored for up to a month for fatigue fracture. The damage tolerance of the external strengthened glass substrate may be about 50% or greater, wherein at least 50% of a minimum of ten samples survives the Indentation Fracture Measurement using the load ranges provided above. In one or more embodiments, the laminate (or one or more substrates of the laminate) exhibits a 50% or greater (e.g., 60% or greater, 70% or greater, 80% or greater or 90% or greater) survival rate under the Indentation Fracture Measurement, using a 20 N load. Such survival is exhibited in laminates including at least one substrate having a thickness of 1 mm or less (e.g., 0.9 mm or less, 0.8 mm or less, or 0.7 mm or less).

In one or more embodiments, the external glass substrate can withstand a surface flaw having a depth of at least 100 μm, or at least 90 μm, or at least 90 μm, before the external strengthened glass substrate fractures.

For lamination, the glass substrates may be heated above the softening point of the interlayer, such as, for example, at least 50° C. or 100° C. above the softening point, to promote bonding of the interlayer material In various embodiments, the laminate may be formed by placing the strengthened glass substrates and interlayer in a pre-press to tack the interlayer to the strengthened glass substrates. Tacking can include expelling most of the air from the interfaces and partially bonding the interlayer to the glass substrates.

During a lamination process, the interlayer may be heated to a temperature effective to soften the interlayer, which promotes a conformal mating of the interlayer to respective surfaces of the strengthened glass substrates.

For a PVB interlayer, a lamination temperature can be about 140° C. The mobile polymer chains within the interlayer material develop bonds with the substrate surfaces, which promote adhesion. Elevated temperatures also accelerate the diffusion of residual air and/or moisture from the glass-polymer interface. The heating can be performed with the glass substrate(s) in contact with the interlayer under pressure. In various embodiments, the application of pressure both promotes flow of the interlayer material, and suppresses bubble formation that otherwise could be induced by the combined vapor pressure of water and air trapped at the interfaces. In various embodiments, a forming process can occur at or just above the softening temperature of the interlayer material (e.g., about 100° C. to about 120° C.), that is, at a temperature less than the softening temperature of the respective strengthened glass substrate(s).

In one or more embodiments, the heat and pressure can be simultaneously applied to the assembly in an autoclave. In various embodiments, the stack of an external strengthened glass substrate, an interlayer, and an internal strengthened glass substrate may be placed within a vacuum bag or a vacuum ring for processing. In various embodiments, the stack and vacuum bag or vacuum ring may be placed with the autoclave.

A specific example of a laminate includes an external glass substrate comprising a thickness of 2.1 mm and comprising an annealed soda-lime glass (ASLG) substrate, a PVB interlayer and an internal glass substrate comprising a thickness of 0.55 mm and comprising a chemically strengthened glass substrate. Another specific example of a laminate includes an external glass substrate comprising a thickness of 2.3 mm and comprising an annealed soda-lime glass (ASLG) substrate, a PVB interlayer, and an internal glass substrate comprising a thickness of 0.4 mm and comprising a chemically strengthened glass substrate.

Another specific example of a laminate includes an external glass substrate comprising a thickness of 1.8 mm and comprising an annealed soda-lime glass (ASLG) substrate, a PVB interlayer, and an internal glass substrate comprising a thickness of 0.4 mm and comprising a chemically strengthened glass substrate. Another specific example of a laminate includes an external glass substrate comprising a thickness of 3.0 mm and comprising an annealed soda-lime glass (ASLG), a PVB interlayer, and an internal glass substrate comprising a thickness of 0.2 mm and comprising a chemically strengthened glass substrate. Other variants are within the scope of the disclosure.

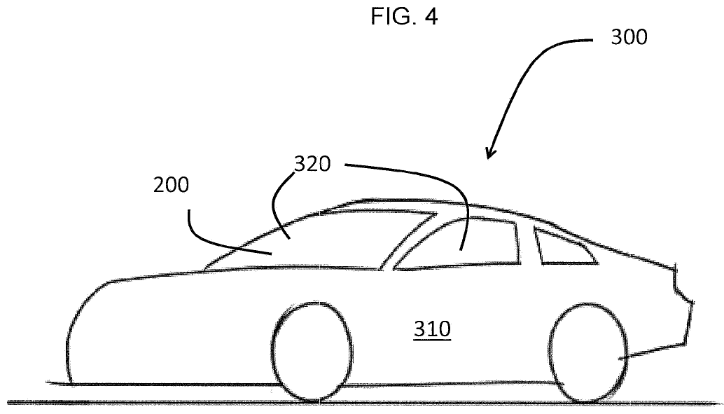

FIG. 4 illustrates an example of a vehicle 300 that includes the laminate 200 shown in FIG. 3. The vehicle includes a body 310 defining an interior and at least one opening 320 in the body. As used herein, the term “vehicle” may include automobiles (e.g., cars, vans, trucks, semi-trailer trucks, and motorcycles), rolling stock, locomotives, train cars, airplanes, and the like. The opening 320 is a window in communication with the interior of the vehicle and the exterior of the vehicle. The laminate 200 is disposed within then at least one opening 320 to provide a transparent covering. The internal glass substrate 100 as shown in FIG. 3 (and in particular first glass surface 105) would face the interior of the vehicle while the external glass substrate 150 (and in particular fourth glass surface 175) would face the exterior of the vehicle. It should be noted that the laminates described herein may be used in architectural panels such as windows, interior wall panels, modular furniture panels, backsplashes, cabinet panels, and/or appliance panels.

### EXAMPLES

### Example 1

Three laminates were constructed:

A conventional laminate (comparative example) was made with an external glass substrate having a thickness of 2.1 mm and including an annealed soda-lime glass (ASLG), a PVB interlayer, and an internal glass substrate having at thickness of 2.1 mm and including an annealed soda-lime glass (ASLG) (labelled as 2.1 ASLG/2.1 ASLG).

An inventive laminate was made with an external glass substrate having a thickness of 2.1 mm and including an annealed soda-lime glass (ASLG), a PVB interlayer, and an internal glass substrate having a thickness of 0.7 mm and a chemically strengthened glass substrate available from Corning Incorporated under the trademark Gorilla® Glass (labelled as 2.1 ASLG/0.7 GG).

An inventive laminate was made with an external glass substrate having a thickness of 2.1 mm and including an annealed soda-lime glass (ASLG), a PVB interlayer, and an internal glass substrate having a thickness of 0.55 mm and a chemically strengthened glass substrate available from Corning Incorporated under the trademark Gorilla® Glass (labelled as 2.1 ASLG/0.55 GG).

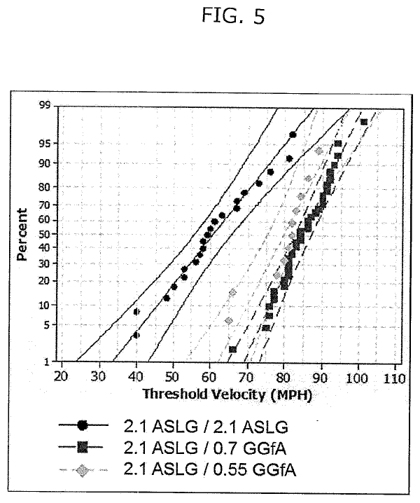

Failure velocities were measured based on the impact of 1 g ball bearing launched at each laminate at 45 degrees angle of incidence. The failure mechanism was Hertzian cone cracking for each sample. Data in FIG. 5 shows that the inventive laminates exhibited approximately 50% greater impact failure velocity than the conventional laminate.

### Example 2

Sharp impact testing of was performed on two samples each of the following laminates:

A conventional laminate (comparative example) was made with an external glass substrate having a thickness of 2.1 mm and including an annealed soda-lime glass (ASLG), a PVB interlayer, and an internal glass substrate having at thickness of 2.1 mm and including an annealed soda-lime glass (ASLG) (labelled as 2.1 ASLG/2.1 ASLG).

An inventive laminate was made with an external glass substrate having a thickness of 2.1 mm and including an annealed soda-lime glass (ASLG), a PVB interlayer, and an internal glass substrate having a thickness of 0.7 mm and a chemically strengthened glass substrate available from Corning Incorporated under the trademark Gorilla® Glass (labelled as 2.1 ASLG/0.7 GG).

An inventive laminate was made with an external glass substrate having a thickness of 2.3 mm and including an annealed soda-lime glass (ASLG), a PVB interlayer, and an internal glass substrate having a thickness of 0.4 mm and a chemically strengthened glass substrate available from Corning Incorporated under the trademark Gorilla® Glass (labeled as 2.3 ASLG/0.4 GG).

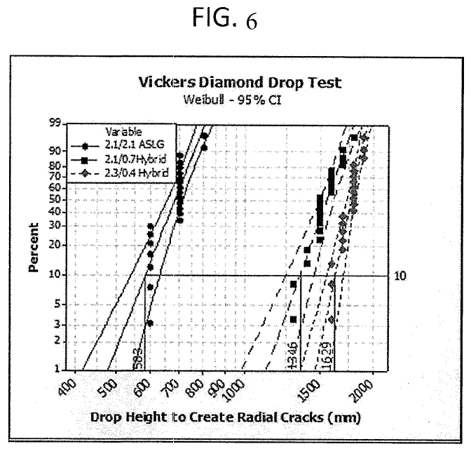

The samples were supported on a perimeter frame that supported the samples at their periphery to allow the samples to flex upon impact. A Vickers diamond indenter (approximately 8.5 g) was dropped as 90 degree angle to each sample. The drop height of the indenter was increased until radial fractures were observed. Analysis of the data on a Weibull plot (FIG. 6) shows 2.1/0.7 hybrid sample outperformed the conventional laminate by 130%, and the 2.3/04 laminate outperformed the conventional laminate by 180%.

### Example 3

Failure rates of laminates A-G (having the structure shown in Table 1) were measured after impact with 1 g ball bearing launched at each laminate at 45 degrees angle of incidence at velocities ranging from 30 miles per hour to 70 miles per hour. The failure rates were measured at different temperatures (i.e., 40° C., 23° C. and −20° C.). The results are shown in Table 2.

Laminates A-G had the following structure.

TABLE 1

| | External | External | Internal | Internal |
|---|---|---|---|---|
| | Glass Sheet | Glass sheet | glass sheet | Glass sheet |
| | (type of | thickness | (type of | thickness |
| Laminate | glass) | (mm) | glass) | (mm) |
| A: 2.1 ASLG/ | ASLG | 2.1 mm | ASLG | 2.1 |
| 2.1 ASLG | | | | |
| (comparative) | | | | |
| B: 1.8 ASLG/ | ASLG | 1.8 mm | ASLG | 1.4 |
| 1.4 ASLG | | | | |
| (comparative) | | | | |
| C: 1.6 ASLG/ | ASLG | 1.6 mm | ASLG | 1.6 |
| 1.6 ASLG | | | | |
| (comparative) | | | | |
| D: 2.1 ASLG/ | ASLG | 2.1 mm | ASLG | 1.0 |
| 1.0 ASLG | | | | |
| (comparative) | | | | |
| E: 2.1 ASLG/ | ASLG | 2.1 mm | Chemically | 0.7 |
| 0.7 GG | | | strengthened | |
| | | | alumino- | |
| | | | silicate | |
| F: 2.3 ASLG/ | ASLG | 2.3 mm | Chemically | 0.4 |
| 0.4 GG | | | strengthened | |
| | | | alumino- | |
| | | | silicate | |
| G: 1.8 ASLG/ | ASLG | 1.8 mm | Chemically | 0.4 |
| 0.4 GG | | | strengthened | |
| | | | alumino- | |
| | | | silicate | |

TABLE 2

| | | % Internal | | |
|---|---|---|---|---|
| | | Glass | % Internal | % Internal |
| | Total | Substrate | Glass | Glass |
| | Thickness | Breakage | Substrate | Substrate |
| Laminate | (mm) | (40° C.) | (23° C.) | (−23° C.) |
| A: 2.1 ASLG/ | 4.0 | 0 | 12% | 0 |
| 2.1 ASLG | | | | |
| B: 1.8 ASLG/ | 4.0 | 30% | 53% | 75% |
| 1.4 ASLG | | | | |
| C: 1.6 ASLG/ | 4.0 | 20% | 88% | 85% |
| 1.6 ASLG | | | | |
| D: 2.1 ASLG/ | 3.9 | 45% | 50% | 100% |
| 1.0 ASLG | | | | |
| E: 2.1 ASLG/ | 3.6 | 0% | 0% | 0% |
| 0.7 GG | | | | |
| F: 2.3 ASLG/ | 3.5 | 0% | 0% | 0% |
| 0.4 GG | | | | |
| G: 1.8 ASLG/ | 3.0 | 0% | 0% | 0% |
| 0.4 GG | | | | |

As shown in Table 2, laminates with thinner and unstrengthened soda-lime glass experienced a high occurrence rate of fracture of the internal glass substrate due to biaxial flexure. Failure rates of such internal glass substrates increased as temperature was reduced while laminates E-G (with thin strengthened internal glass substrates) had zero failures.

Three different fracture mechanisms of laminates A-G were examined. The blunt impact fracture mechanism analysis indicated that the laminates E-G exhibited 50% improved failure rates over the laminates B-D, which included thinner glass substrates. The flexure mechanism analysis showed the internal glass substrates of laminates B-D failed while the internal glass substrates of laminates E-G survived. The sharp impact mechanism analysis showed that laminated E-G showed 130% improvement in failure rates over laminates B-D.

Aspect (1) of this disclosure pertains to a laminate comprising: an external glass substrate comprising a glass substrate having a first thickness (tₒ); an interlayer disposed on the external glass substrate; and an internal glass substrate disposed on the interlayer, the internal glass substrate comprising a strengthened glass substrate and a second thickness (tᵢ) in a range of 0.05 mm and 1 mm such that tit, is in a range from about 3 to about 20.

Aspect (2) of this disclosure pertains to the laminate according Aspect (1), wherein the laminate comprises a total thickness in the range from about 2 mm to about 7 mm.

Aspect (3) of this disclosure pertains to the laminate according to Aspect (1) or Aspect (2), wherein tₒ is in a range of 1.5 mm and 3 mm.

Aspect (4) of this disclosure pertains to the laminate according to any one of Aspect (1) through Aspect (3), wherein tᵢ is in a range of 0.05 mm and 0.7 mm.

Aspect (5) of this disclosure pertains to the laminate according to any one of Aspect (1) through Aspect (4), wherein tᵢ is in a range of 0.05 mm and 0.5 mm.

Aspect (6) of this disclosure pertains to the laminate according to any one of Aspect (1) through Aspect (5), wherein tₒ/tᵢ is in a range of 3 and 15.

Aspect (7) of this disclosure pertains to the laminate according to any one of Aspect (1) through Aspect (6), wherein tₒ/tᵢ is in a range of 3.5 and 10.

Aspect (8) of this disclosure pertains to the laminate according to any one of Aspect (1) through Aspect (7), wherein the external glass substrate comprises a strengthened glass substrate.

Aspect (9) of this disclosure pertains to the laminate according to any one of Aspect (1) through Aspect (8), wherein the external glass substrate comprises an annealed and unstrengthened glass substrate.

Aspect (10) of this disclosure pertains to the laminate according to any one of Aspect (1) through Aspect (8), wherein the external glass substrate comprises a thermally strengthened glass substrate.

Aspect (11) of this disclosure pertains to the laminate according to any one of Aspect (1) through Aspect (8), wherein the external glass substrate comprises a chemically strengthened glass substrate.

Aspect (12) of this disclosure pertains to the laminate according to any one of Aspect (1) through Aspect (11), wherein the internal glass substrate comprises a chemically strengthened glass substrate.

Aspect (13) of this disclosure pertains to the laminate according Aspect (12), wherein the internal glass substrate comprises an alkali aluminosilicate glass composition, or an alkali aluminoborosilicate glass composition.

Aspect (14) of this disclosure pertains to the laminate according to any one of Aspect (1) through Aspect (13), wherein the internal glass substrate comprises a DOC in a range from about 30 μm to about 90 μm.

Aspect (15) of this disclosure pertains to the laminate according to Aspect (14), wherein the internal glass substrate comprises a surface CS in a range from about 300 MPa to 1000 MPa.

Aspect (16) of this disclosure pertains to the laminate according to Aspect (15), wherein the CS is in the range from about 600 MPa to about 1000 MPa.

Aspect (17) of this disclosure pertains to the laminate according to any one of Aspect (1) through Aspect (16), wherein the interlayer is a polymer selected from the group consisting of polyvinyl butyral, ethylenevinylacetate, polyvinyl chloride, ionomers, and thermoplastic polyurethane.

Aspect (18) of this disclosure pertains to the laminate according to any one of Aspect (1) through Aspect (17), wherein the laminate comprises any one of a heads-up display, a projection surface, an antenna, a surface modification and a coating.

Aspect (19) of this disclosure pertains to a laminate comprising: an external glass substrate comprising an unstrengthened glass substrate having a thickness (tₒ) in a range of 1.5 mm and 3 mm; an interlayer disposed on the external glass substrate; and an internal glass substrate disposed on the interlayer, the internal glass substrate comprising a chemically strengthened glass substrate and a thickness (tᵢ) in a range from about 0.05 mm to about 0.7 mm such that tₒ/tᵢ is in a range from about 3 to about 20.

Aspect (20) of this disclosure pertains to a vehicle comprising: a body defining an interior; an opening in the body in communication with the interior; and the laminate according to any one of Aspect (1) through Aspect (19) disposed in the opening.

Aspect (21) pertains to the vehicle according to Aspect (20), wherein the body comprises an automobile body, a railcar body, or an airplane body.

Aspect (22) pertains to the vehicle according to Aspect (20) or Aspect (21), wherein the internal glass substrate faces the interior of the vehicle.

Aspect (23) pertains to an architectural panel comprising the laminate according to any one of Aspect (1) through Aspect (18), wherein the panel comprises a window, an interior wall panel, a modular furniture panel, a backsplash, a cabinet panel, or an appliance panel.

Aspect (24) pertains to a method of manufacturing a laminate comprising: disposing an interlayer between an external glass substrate and an internal glass substrate to form a stack, the external glass substrate comprising a thickness (tₒ), the internal glass substrate comprising a strengthened glass substrate and a thickness (tᵢ) in a range from about 0.05 mm to about 1 mm such that tₒ/tᵢ is in a range from about 3 to about 20; and applying heat and pressure to the stack to form the laminate.

Although the disclosure herein has been described with reference to particular embodiments, it is to be understood that these embodiments are merely illustrative of the principles and applications of the present disclosure. It will be apparent to those skilled in the art that various modifications and variations can be made to the method and apparatus of the present disclosure without departing from the spirit and scope of the disclosure. Thus, it is intended that the present disclosure include modifications and variations that are within the scope of the appended claims and their equivalents.

1. A laminate comprising:
an external glass substrate comprising a glass substrate having a first thickness (tₒ);
an interlayer disposed on the external glass substrate; and
an internal glass substrate disposed on the interlayer, the internal glass substrate comprising a strengthened glass substrate and a second thickness (ti) in a range of 0.05 mm and 1 mm such that tₒ/tᵢ is in a range from about 3 to about 20,
wherein tᵢ is in a range of 0.05 mm and 0.5 mm.

2. The laminate of claim 1, wherein the laminate comprises a total thickness in the range from about 2 mm to about 7 mm.

3. The laminate of claim 1, wherein tₒ is in a range of 1.5 mm and 3 mm.

4. (canceled)

5. (canceled)

6. (canceled)

7. (canceled)

8. The laminate of claim 1, wherein the external glass substrate comprises a strengthened glass substrate.

9. The laminate of claim 1, wherein the external glass substrate comprises an annealed and unstrengthened glass substrate.

10. The laminate of claim 1, wherein the external glass substrate comprises a thermally strengthened glass substrate.

11. The laminate of claim 1, wherein the external glass substrate comprises a chemically strengthened glass substrate.

12. The laminate of claim 1, wherein the internal glass substrate comprises a chemically strengthened glass substrate.

13. The laminate of claim 12, wherein the internal glass substrate comprises an alkali aluminosilicate glass composition, or an alkali aluminoborosilicate glass composition.

14. The laminate of claim 1, wherein the internal glass substrate comprises a chemically strengthened glass substrate and a DOC in a range from about 30 μm to about 90 μm.

15. The laminate of claim 14, wherein the internal glass substrate comprises a surface CS in a range from about 300 MPa to 1000 MPa.

16. The laminate of claim 15, wherein the CS is in the range from about 600 MPa to about 1000 MPa.

17. The laminate of claim 1, wherein the interlayer is a polymer selected from the group consisting of polyvinyl butyral, ethylenevinylacetate, polyvinyl chloride, ionomers, and thermoplastic polyurethane.

18. The laminate of claim 1, wherein the laminate comprises any one of a heads-up display, a projection surface, an antenna, a surface modification and a coating.

19. A laminate comprising:
an external glass substrate comprising an unstrengthened glass substrate having a thickness (tₒ) in a range of 1.5 mm and 3 mm;
an interlayer disposed on the external glass substrate; and
an internal glass substrate disposed on the interlayer, the internal glass substrate comprising a chemically strengthened glass substrate and a thickness (tᵢ) in a range from about 0.05 mm to about 0.5 mm such that tₒ/tᵢ is in a range from about 3 to about 20.

20. A vehicle comprising: a body defining an interior; an opening in the body in communication with the interior; and the laminate of claim 1 disposed in the opening.

21. The vehicle of claim 20, wherein the body comprises an automobile body, a railcar body, or an airplane body.

22. The vehicle of claim 20, wherein the internal glass substrate faces the interior.

23. An architectural panel comprising the laminate of claim 1, wherein the panel comprises a window, an interior wall panel, a modular furniture panel, a backsplash, a cabinet panel, or an appliance panel.

24. A method of manufacturing a laminate comprising:
disposing an interlayer between an external glass substrate and an internal glass substrate to form a stack, the external glass substrate comprising a thickness (tₒ), the internal glass substrate comprising a strengthened glass substrate and a thickness (tᵢ) in a range from about 0.05 mm to about 0.5 mm such that tₒ/tᵢ is in a range from about 3 to about 20; and
applying heat and pressure to the stack to form the laminate.
